(19) United States
(12) Patent Application Publication
(10) Pub. No.: US 2026/0036265 A1
(43) Pub. Date: Feb. 5, 2026

(54) METHODS, SYSTEMS, AND STORAGE MEDIA FOR SMART GAS UNMANNED INSPECTION BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Guobin LUO, Chengdu (CN); Lei HE, Chengdu (CN)

(73) Assignee: CHENGDU QINCHUAN IOT TECHNOLOGY CO., LTD., Chengdu (CN)

(21) Appl. No.: 19/358,402

(22) Filed: Oct. 14, 2025

(30) Foreign Application Priority Data
Sep. 2, 2025 (CN) 202511241801.1

(51) Int. Cl. F17D 5/00; F17D 5/02; G06Q 10/20; G06Q 50/06

(52) U.S. Cl. CPC F17D 5/005; F17D 5/02; G06Q 10/20; G06Q 50/06

(57) ABSTRACT

Disclosed herein are a method, a system, and a storage medium for smart gas unmanned inspection based on an Internet of Things (IoT). The method includes: obtaining region data of a management region; determining whether to identify the management region as a region to be inspected based on the region data and traffic data of the management region; in response to determining that the management region is identified as the region to be inspected, determining an inspection parameter of the region to be inspected; the inspection parameter being related to at least one of a pipeline monitoring device, an inspector, and an unmanned inspection device; and sending the inspection parameter to the government safety monitoring object platform to control at least one of the pipeline monitoring device, the inspector, and the unmanned inspection device to complete an inspection of the region to be inspected.

### CROSS-REFERENCE TO RELATED APPLICATIONS

This application claims priority to the Chinese Patent Application No. 202511241801.1, filed on Sep. 2, 2025, the contents of which are hereby incorporated by reference.

### TECHNICAL FIELD

The present disclosure relates to the field of gas pipeline network inspection, and in particular relates to a method, a system, and a storage medium for smart gas unmanned inspection based on an Internet of Things (IoT).

### BACKGROUND

Gas pipelines, as an important part of urban infrastructure, have a direct relationship between the safe and stable operation and all aspects of residents' lives and urban development. Regular inspections of the gas pipelines and timely detection and treatment of potential safety hazards are key measures to ensure the safety of gas supply. Traditional gas pipeline inspection mainly relies on manual labor, making it difficult to ensure the comprehensiveness and accuracy of the process. When faced with complex inspection environments, the difficulty and risks of the inspection also increase significantly.

Therefore, it is hoped to propose a method for smart gas unmanned inspection based on an Internet of Things (IoT) to better complete the inspection of the gas pipelines.

### SUMMARY

One or more embodiments of the present disclosure provide a system for smart gas unmanned inspection based on an Internet of Things (IoT), comprising a government safety monitoring and management platform, a government safety monitoring sensor network platform, a government safety monitoring object platform, a gas company sensor network platform, and a gas inspection object platform; wherein the gas inspection object platform includes an unmanned inspection device; and the government safety monitoring object platform includes a gas company management platform; the government safety monitoring and management platform is configured to: obtain, through the government safety monitoring sensor network platform, region data of a management region from the gas company management platform in the government safety monitoring object platform, the region data including at least one of ground image information, macroscopic image information, air data, and environmental data; wherein the gas company management platform obtains the region data from the gas inspection object platform through the gas company sensor network platform; determine whether to identify the management region as a region to be inspected based on the region data and traffic data of the management region; in response to determining that the management region is identified as the region to be inspected, determine an inspection parameter of the region to be inspected; and send the inspection parameter to the government safety monitoring object platform to control at least one of the pipeline monitoring device, the inspector, and the unmanned inspection device to complete an inspection of the region to be inspected.

One or more embodiments of the present disclosure provide a method for smart gas unmanned inspection based on an Internet of Things (IoT). The method comprises: obtaining, through a government safety monitoring sensor network platform, region data of a management region from a gas company management platform in a government safety monitoring object platform, the region data including at least one of ground image information, macroscopic image information, air data, and environmental data; wherein the gas company management platform obtains the region data from a gas inspection object platform through a gas company sensor network platform; determining whether to identify the management region as a region to be inspected based on the region data and traffic data of the management region; in response to determining that the management region is identified as the region to be inspected, determining an inspection parameter of the region to be inspected; the inspection parameter being related to at least one of a pipeline monitoring device, an inspector, and an unmanned inspection device; and sending the inspection parameter to the government safety monitoring object platform to control at least one of the pipeline monitoring device, the inspector, and the unmanned inspection device to complete an inspection of the region to be inspected.

One or more embodiments of the present disclosure provide a non-transitory computer-readable storage medium storing computer instructions, wherein when a computer reads the computer instructions in the storage medium, the computer implements a method for smart gas unmanned inspection based on an Internet of Things (IoT).

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform structure of a system for smart gas unmanned inspection based on an Internet of Things (IoT) according to some embodiments of the present disclosure;

FIG. 2 is an exemplary flowchart illustrating a method for smart gas unmanned inspection based on an Internet of Things (IoT) according to some embodiments of the present disclosure;

FIG. 3 is a schematic diagram illustrating a process for determining a region to be inspected according to some embodiments of the present disclosure; and

FIG. 4 is an exemplary flowchart illustrating a process for determining an inspection parameter according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for a person of ordinary skill in the art to apply the present disclosure to other similar scenarios according to these drawings without creative labor. Unless obviously obtained from the context or the context illustrates otherwise, the same numeral in the drawings refers to the same structure or operation.

It should be understood that, as used herein, the terms “system”, “device”, “unit” and/or “module” are used herein as a way to distinguish between different components, elements, parts, sections or assemblies at different levels. However, the words may be replaced by other expressions if other words accomplish the same purpose.

Flowcharts are used in the present disclosure to illustrate operations performed by a system according to embodiments of the present disclosure. It should be appreciated that the preceding or following operations are not necessarily performed in an exact sequence. Instead, operations may be processed in reverse order or simultaneously. Also, it is possible to add other operations to these processes, or to remove a step or steps from these processes.

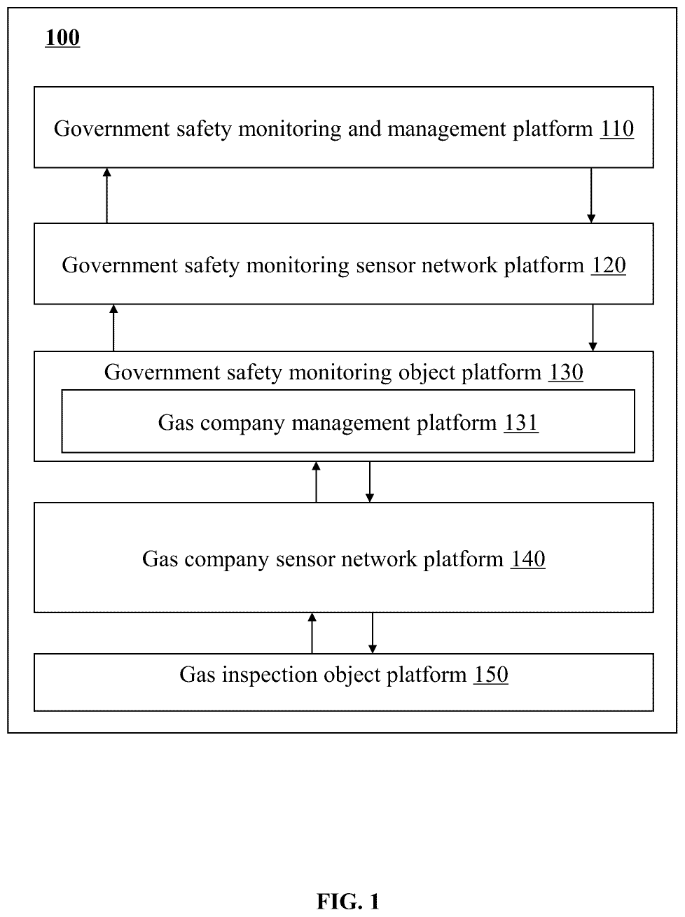

FIG. 1 is a schematic diagram illustrating a platform structure of a system for smart gas unmanned inspection based on an Internet of Things (IoT) according to some embodiments of the present disclosure.

In some embodiments, as shown in FIG. 1, the system 100 for smart gas unmanned inspection based on the IoT may include a government safety monitoring and management platform 110, a government safety monitoring sensor network platform 120, a government safety monitoring object platform 130, a gas company sensor network platform 140, and a gas inspection object platform 150.

The government safety monitoring and management platform 110 refers to a comprehensive management platform for processing and monitoring information by the government.

In some embodiments, the government safety monitoring and management platform 110 is configured to perform a method for smart gas unmanned inspection based on the IoT, details of which may be found in the relevant description later in the present disclosure.

In some embodiments, the government safety monitoring and management platform 110 may be configured on a processor and/or a server used by the government. The processor and/or the server may process data and/or information obtained from other platforms and execute program instructions based on the data, the information, and/or processing results to perform one or more functions described in the present disclosure.

In some embodiments, the government safety monitoring and management platform 110 may interact with the government safety monitoring object platform 130 via the government safety monitoring sensor network platform 120 for data interaction.

The government safety monitoring sensor network platform 120 refers to an interface platform that enables interaction between the government safety monitoring and management platform 110 and the government safety monitoring object platform 130, and is configured as a communication device and/or a server.

In some embodiments, the government safety monitoring sensor network platform 120 may be configured as a communication network, a gateway, etc., and may implement the functions of sensing information communication and control information communication.

The government safety monitoring object platform 130 refers to a platform for generating monitoring information and executing control information for the government. In some embodiments, the government safety monitoring object platform 130 includes a gas company management platform 131.

In some embodiments, the government safety monitoring object platform 130 interacts upwardly with the government safety monitoring sensor network platform 120 and downwardly with the gas company sensor network platform 140.

The gas company management platform 131 refers to a comprehensive management platform for information about a gas company.

The gas company sensor network platform 140 refers to a platform for managing sensing information of the gas company. In some embodiments, the gas company sensor network platform 140 may be configured as a communication network, a gateway, etc.

In some embodiments, the gas company sensor network platform 140 interacts upwardly with the government safety monitoring object platform 130 and downwardly with the gas inspection object platform 150 for data interaction.

The gas inspection object platform 150 refers to a functional platform for generating sensing information and executing control information for the gas company. In some embodiments, the gas inspection object platform 150 includes an unmanned inspection device.

The unmanned inspection device refers to an inspection device that does not require a human to operate. In some embodiments, the unmanned inspection device may include, but is not limited to, a drone, an unmanned vehicle, and an environmental monitoring device, a gas monitoring device, a sensor, an image acquisition device, and/or laser point cloud device mounted on the drone of the unmanned vehicle, etc.

In some embodiments of the present disclosure, the system for smart gas unmanned inspection based on the IoT can form a closed loop of information operation among functional platforms and operate in a coordinated and regular manner under the unified management of the gas company management platform, so as to realize the informatization and intellectualization of the smart gas unmanned inspection.

In some embodiments, when realizing a method for smart gas unmanned inspection based on an Internet of Things (IoT), the government safety monitoring and management platform may obtain, through the government safety monitoring sensor network platform, region data of a management region from the gas company management platform in the government safety monitoring object platform; determine whether to identify the management region as a region to be inspected based on the region data and traffic data of the management region; in response to determining that the management region is identified as the region to be inspected, determine an inspection parameter of the region to be inspected; and send the inspection parameter to the government safety monitoring object platform to control at least one of the pipeline monitoring device, the inspector, and the unmanned inspection device to complete an inspection of the region to be inspected.

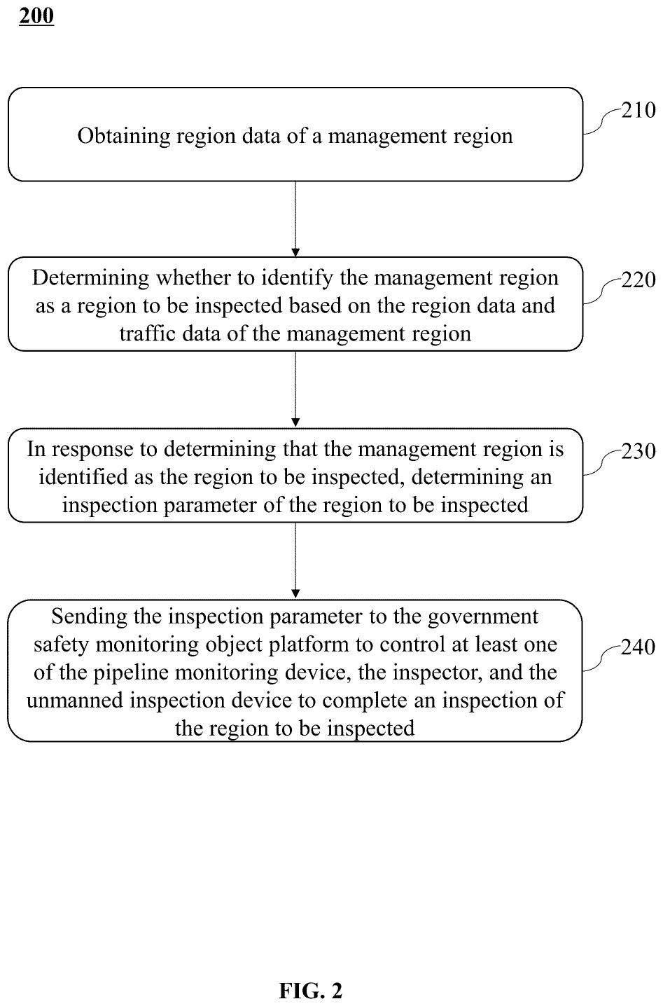

FIG. 2 is an exemplary flowchart illustrating a method for smart gas unmanned inspection based on an Internet of Things (IoT) according to some embodiments of the present disclosure.

As shown in FIG. 2, process 200 includes the following operations. In some embodiments, the process 200 may be performed by the government safety monitoring and management platform 110.

In 210, region data of a management region may be obtained.

The management region refers to a region obtained by dividing a range in which a gas pipeline network is laid.

In some embodiments, the government safety monitoring and management platform may obtain a plurality of management regions by dividing the range in which the gas pipeline network is laid according to preset criteria. For example, the preset criteria may include differences in management personnel.

The region data refers to data reflecting information about regions in the management region. In some embodiments, the region data includes at least one of ground image information, macroscopic image information, air data, and environmental data.

The ground image information refers to image data reflecting information about a surface of the management region. For example, the ground image information may include data indicating undulation of the ground surface, etc. In some embodiments, the ground image information may be represented by point cloud data and/or pictures, etc.

The macroscopic image information refers to image data reflecting overall condition of the management region. For example, the macroscopic image information may include data reflecting environment and humanities of the management region.

The air data refers to data reflecting air conditions. For example, the air data may include, but is not limited to, composition, content, etc. of gases in the air.

The environmental data refers to data reflecting environmental conditions. For example, the environmental data may include, but is not limited to, temperature, humidity, or the like.

In some embodiments, the ground image information and the macroscopic image information may be obtained by an image acquisition device set up in the gas inspection object platform, the air data and the environmental data may be obtained by sensors set up in the gas inspection object platform, and the aforementioned data are sent to the gas company management platform through the gas company sensor network platform.

In some embodiments, the government safety monitoring and management platform may obtain the region data of the management region from the gas company management platform in the government safety monitoring object platform through the government safety monitoring sensor network platform. The gas company management platform may obtain the region data from the gas inspection object platform through the gas company sensor network platform.

In 220, it may be determined whether to identify the management region as a region to be inspected based on the region data and traffic data of the management region.

The traffic data refers to data reflecting traffic conditions. For example, the traffic data may include, but is not limited to, a traffic flow on a roadway, etc.

In some embodiments, the government safety monitoring and management platform may obtain the traffic data through an external platform. For example, the external platform includes a traffic monitoring center, a map service provider, or the like.

The region to be inspected refers to the management region that needs to be inspected.

In some embodiments, the government safety monitoring and management platform may determine a gas leakage in the management region based on the air data, determine the traffic flow in the management region based on the traffic data, determine surface elevation data in the management region based on the ground image information, determine a building density and a road density based on the macroscopic image information, determine temperature and humidity based on the environmental data; and determine whether to identify the management region as the region to be inspected based on at least one of the gas leakage, the traffic flow, the surface elevation data, the building density, the road density, the temperature, and the humidity.

The gas leakage refers to data reflecting whether there is a gas leak. If a percentage of the air in the management region that contains gas exceeds a content threshold, it is determined that there is the gas leak in the management region. The content threshold may be determined based on a priori experience.

The surface elevation data refers to data reflecting elevation features of the region. In some embodiments, the surface elevation data may include an elevation of at least one point within the management region.

The building density refers to data reflecting building footprint. In some embodiments, the building density may be determined based on a percentage of a floor area in the management region to a total area of the management region.

The road density refers to data reflecting how densely roads are distributed. In some embodiments, the road density may be determined based on a road length that has per unit area in the management region.

In some embodiments, determining whether to identify the management region as the region to be inspected includes at least one stage of determination.

Exemplarily, the government safety monitoring and management platform may perform a first stage of determination based on the gas leakage in the management region. If the gas leak exists in the management region, the management region is identified as the region to be inspected, and if the gas leak does not exist, the second stage of determination is entered.

Exemplarily, the government safety monitoring and management platform may perform the second stage of determination based on the traffic flow, the surface elevation data, the building densities, and the road density in the management region. The second stage of determination includes determining whether at least one of the following conditions is met in the management region: the traffic flow exceeds a flow threshold, a variance of the surface elevation data exceeds an elevation threshold, the building density exceeds a building density threshold, the road density exceeds a road density threshold, the temperature exceeds a temperature threshold, or the humidity exceeds a humidity threshold. If the condition of the management region meets N or more of the preceding conditions, the management region is determined to be the region to be inspected. Nis an integer greater than 1 and not greater than 6, which may be determined according to the actual needs. The flow threshold, the elevation threshold, the building density threshold, the road density threshold, the temperature threshold, and the humidity threshold may be determined based on a priori experience and/or actual needs.

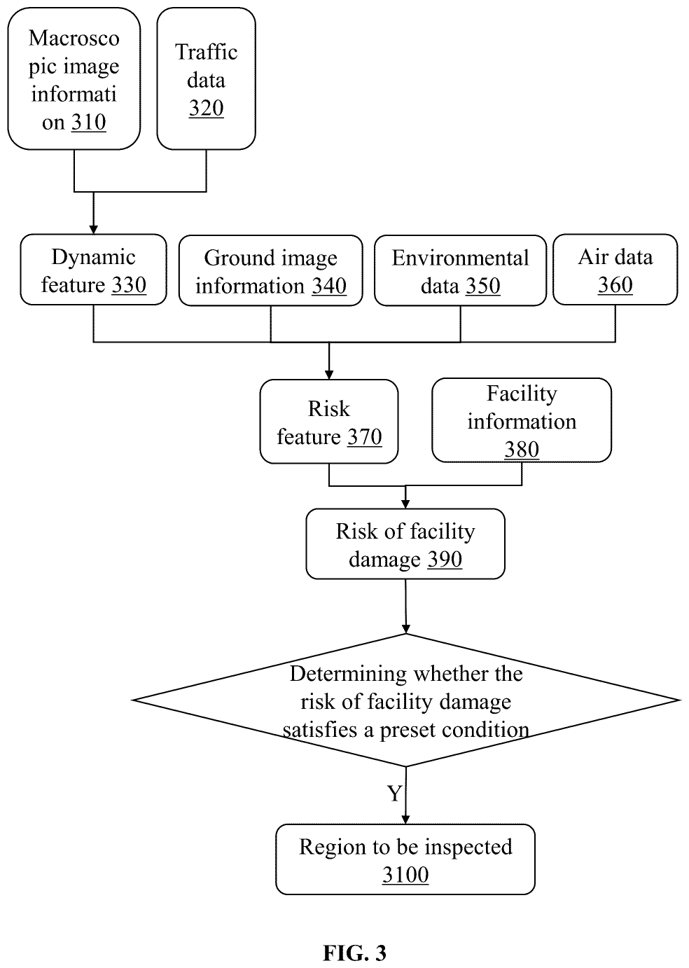

In some embodiments, the government safety monitoring and management platform may also determine a dynamic feature of the management region based on the macroscopic image information and the traffic data; determine a risk feature of a gas pipeline in the management region based on the ground image information, the environmental data, the air data, and the dynamic feature; determine a risk of facility damage based on the risk feature and facility information of a gas-related infrastructure; and in response to determining that the risk of facility damage satisfies a preset condition, identify the management region as the region to be inspected. More details may be found in FIG. 3 of the present disclosure and the related description.

In 230, in response to determining that the management region is identified as the region to be inspected, an inspection parameter of the region to be inspected may be determined.

The inspection parameter refers to a parameter used to guide an inspection process. In some embodiments, the inspection parameter is related to at least one of a pipeline monitoring device, an inspector, and an unmanned inspection device.

In some embodiments, in response to determining that the management region is identified as the region to be inspected, the government safety monitoring and management platform may determine the inspection parameter based on a preset rule. The preset rule may include: determining at least one of a second acquisition parameter of the unmanned inspection device, a scheduling instruction corresponding to the inspector, when the management region is identified as the region to be inspected in the first stage of determination; and when the management region is identified as the region to be inspected at the second stage of determination, determining at least one monitoring device to be enabled and a monitoring frequency of the monitoring device to be enabled.

The second acquisition parameter is used to instruct the unmanned inspection device to perform hovering monitoring along the top of the gas pipeline to obtain the air data. The second acquisition parameter may include, but is not limited to, at least one of a path, a hover time. The path may be determined based on a distribution of the gas pipelines in the region to be inspected, and the hover time may be determined based on a priori experience. In some embodiments, the hover time is also related to a count of downstream users of the gas pipeline, and the greater the count of the downstream users, the longer the hover time.

The scheduling instruction refers to an instruction for instructing an inspector to monitor the gas pipeline. In some embodiments, the government safety monitoring and management platform may determine whether the gas leak exists in the management region based on the air data obtained by the unmanned inspection device according to the second acquisition parameter, in response to the presence of one or more leak locations, the government safety monitoring and management platform may generate the scheduling instruction based on coordinates of the leak locations and send the scheduling instruction to a terminal corresponding to the inspector to arrange for the corresponding monitor to conduct the inspection.

The monitoring device to be enabled refers to a pipeline monitoring device that needs to be turned on. In some embodiments, the government safety monitoring and management platform may determine the monitoring device to be enabled based on size of the N used in the second stage of determination and a grade of the pipeline monitoring device. Exemplarily, the government safety monitoring and management platform may turn on the pipeline monitoring device in order according to a grade from the top to the bottom. The larger the value of N is, the stricter the second stage of determination is, and the smaller the count of the pipeline monitoring device to be turned on is at this time.

The grade of the pipeline monitoring device is positively related to importance of the data obtained by the pipeline monitoring device. The importance of the data may be determined by a frequent term algorithm based on metrics related to historical incidents. For example, a high count of historical accidents related to a metric indicates that the metric is important.

The monitoring frequency refers to a frequency with which gas pipeline data is obtained through the pipeline monitoring device. The monitoring frequency is negatively related to a count of the monitoring device to be enabled.

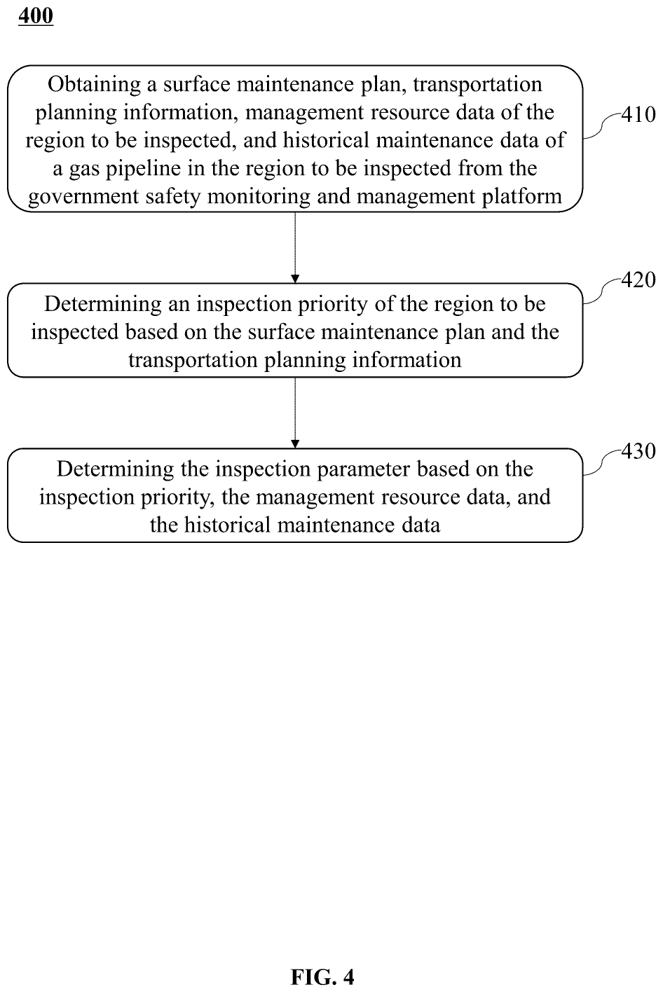

In some embodiments, the government safety monitoring and management platform may also determine an inspection priority of the region to be inspected based on a surface maintenance plan and transportation planning information of the management region; and determine the inspection parameter based on the inspection priority, management resource data of the management region, and historical maintenance data. More details may be found in FIG. 4 of the present disclosure and the related description.

In 240, the inspection parameter may be sent to the government safety monitoring object platform to control at least one of the pipeline monitoring device, the inspector, and the unmanned inspection device to complete an inspection of the region to be inspected.

In some embodiments, the government safety monitoring and management platform may send the inspection parameter to the government safety monitoring object platform, and further control at least one of the pipeline monitoring device, the inspector, and the unmanned inspection device to complete the inspection of the region to be inspected through the government safety monitoring object platform.

Exemplarily, in response to determining that the management region is identified as the region to be inspected during the first stage of determination, the government safety monitoring and management platform may send the second acquisition parameter to the unmanned inspection device to control the unmanned inspection device to perform hovering monitoring along the gas pipeline according to the second acquisition parameter, determine whether there is a gas leakage location according to the data obtained by the unmanned inspection device, and if there is the gas leakage location, send the scheduling instruction to the terminal corresponding to the inspector to instruct the inspector to carry out a manual inspection.

In response to determining that the management region is identified as the region to be inspected during the second stage of determination, the government safety monitoring and management platform may send the monitoring device to be enabled and the monitoring frequency to the pipeline monitoring device, to control the relevant pipeline monitoring device to obtain the data of the gas pipeline according to the monitoring frequency. At this time, the government safety monitoring and management platform may also send the monitoring device to be enabled and the monitoring frequency to the terminal corresponding to the inspector to synchronize the relevant information.

In some embodiments of the present disclosure, the government safety monitoring and management platform can determine whether the inspection is required for the management region based on the region data, and when the inspection is deemed necessary, can identify the appropriate inspection parameter and carry out inspection on the region to be inspected. The approach enables more targeted and timely inspections, ensuring more reliable results and facilitating the smooth progression of subsequent troubleshooting efforts.

FIG. 3 is a schematic diagram illustrating a process for determining a region to be inspected according to some embodiments of the present disclosure.

In some embodiments, as shown in FIG. 3, the government safety monitoring and management platform may determine a dynamic feature 330 of a management region based on macroscopic image information 310 and traffic data 320; determine a risk feature 370 of a gas pipeline in the management region based on ground image information 340, environmental data 350, air data 360, and the dynamic feature 330; determine a risk of facility damage 390 based on the risk feature 370 and facility information 380 of a gas-related infrastructure; and in response to determining that the risk of facility damage 390 satisfies a preset condition, identify the management region as a region to be inspected 3100.

More details regarding the ground image information, the macroscopic image information, the air data, the environmental data, the management region, and the region to be inspected may be found in the corresponding descriptions of FIG. 2.

The dynamic feature refers to a parameter related to measurement of surface pressure. The dynamic feature may be used to reflect effects of construction (scale, noise level), traffic, pedestrian flow, etc. on the surface pressure.

In some embodiments, the government safety monitoring and management platform determines the dynamic features in a plurality of ways based on the macroscopic image information and the traffic data. For example, the government safety monitoring and management platform may determine the dynamic feature based on positive correlation between the macroscopic image information, the traffic data, and the dynamic feature through a preset formula. Exemplarily, the preset formula is shown in formula (1) below:

$$D = {w}_{1} \times {B}_{d} + {w}_{2} \times {R}_{d} + {w}_{3} \times {F}_{av} , \qquad ( 1 )$$

wherein, D denotes the dynamic feature, B_{d} denotes a building density in the macroscopic image information, R_{d} denotes a road density in the macroscopic image information, Fₐᵥ denotes an average flow of a road, and w₁, w₂, and w₃ are order of magnitude parameters. w₁, w₂, and w₃ may be preset based on experience or set by system default.

In some embodiments, the government safety monitoring and management platform may determine the dynamic feature based on the macroscopic image information, the traffic data, noise information and vibration information in the management region.

The noise information refers to information related to noise features in the management region. For example, the noise information may include noise frequencies of a plurality of noises.

The vibration information refers to information related to vibration features in the management region. For example, the vibration information may include vibration frequencies of a plurality of vibrations.

In some embodiments, the dynamic feature is positively related to the macroscopic image information, the traffic data, the noise information and the vibration information in the management region. The government safety monitoring and management platform may determine the dynamic feature based on the macroscopic image information, the traffic data, the noise information and the vibration information in the management region through a preset formula. Exemplarily, the preset formula is shown in formula (2) below:

$$D = {w}_{1} \times {B}_{d} + {w}_{2} \times {R}_{d} + {w}_{3} \times {F}_{av} + {w}_{4} \times {N}_{f} + {w}_{5} \times {V}_{f} , \qquad ( 2 )$$

wherein, N_{f} denotes an average noise frequency of the plurality of noises, V_{f} denotes an average vibration frequency of the plurality of vibrations, and w₄ and w₅ are order of magnitude parameters. w₄ and w₅ may be preset based on experience or set by system default.

Resonance caused by sound waves and energy carried by the sound waves affect the condition of the ground surface, causing it to vibrate, or the like.

In some embodiments of the present disclosure, consideration of the effects of noise and vibration on the dynamic feature is conducive to determining the dynamic feature more accurately, thereby ensuring the accuracy of the data such as the risk feature determined subsequently, and enhancing the efficiency of determining the region to be inspected.

The risk feature refers to data related to risk of a gas pipeline in the management region. In some embodiments, the risk feature includes a risk type and a risk intensity.

The risk type includes an active risk and a passive risk. The active risk refers to a risk associated with the gas pipeline itself, for example, a risk due to pipeline aging and disrepair, etc. The passive risk refers to a risk due to external pressures, interferences, etc.

The risk intensity refers to data that characterizes magnitude of a likelihood of the presence of risk in the gas pipeline.

In some embodiments, the government safety monitoring and management platform may determine the risk feature of the gas pipeline in the management region based on the ground image information, the environmental data, the air data, and the dynamic feature.

For example, the government safety monitoring and management platform may determine whether temperature in the environmental data is greater than a temperature threshold, or whether humidity is greater than a humidity threshold, or whether the dynamic feature is greater than a dynamic threshold. And if one of the above three conditions is satisfied, the risk type may be identified as the passive risk, otherwise it is the active risk.

For example, the government safety monitoring and management platform may determine the risk intensity based on determination results of at least one of the following assessment items: the ground image information, the environmental data, the air data, and the dynamic feature. The assessment items include: a) determining that a variance of surface elevation is greater than an elevation threshold based on the ground image information, b) determining that the temperature is greater than the temperature threshold based on the environmental data, c) determining that the humidity is greater than the humidity threshold based on the environmental data, d) determining that there is a gas leakage in the management region based on the air data, e) determining that the average flow of the road in the management region is greater than a flow threshold based on the traffic data, f) determining that the dynamic feature is greater than the dynamic threshold based on the dynamic feature.

Exemplarily, the government safety monitoring and management platform may determine the risk intensity based on an initial risk degree and the aforementioned determination results through a preset formula. The preset formula is shown in formula (3) below:

$$R = α + n / 6 , \qquad ( 3 )$$

wherein, R denotes the risk intensity, α denotes the initial risk degree, and n denotes a count of assessment items that satisfy the determination. α may be preset by a staff member based on experience or set by system default.

The temperature threshold, the humidity threshold, the dynamic threshold, the elevation threshold, and the flow threshold are preset thresholds for the temperature, the humidity, the dynamic feature, the variance of the elevation, and the average flow of the road, respectively. The temperature threshold, the humidity threshold, the dynamic threshold, the elevation threshold, and the flow threshold may be preset by a staff member based on experience or set by system default.

In some embodiments, the government safety monitoring and management platform may determine a predicted dynamic feature of the management region in a preset future time period through a first prediction model, based on the environmental data and the dynamic feature; determine predicted air data of the management region in the preset future time period through a second prediction model, based on the air data and the environmental data; and determine the risk feature of the management region through a third prediction model based on the ground image information, the predicted dynamic feature, and the predicted air data.

The preset future time period refers to a preset period of time in the future, for example, 0.5 h in the future, 1 h in the future, or the like.

The predicted dynamic feature refers to a relevant parameter that measures the surface pressure over the preset future time period.

The predicted air data refers to data related to air features over the preset future time period.

In some embodiments, the first prediction model may be a machine learning model. For example, the first prediction model includes a Neural Networks (NN) model or other trained machine learning models.

In some embodiments, an input of the first prediction model includes the environmental data and the dynamic feature, and an output includes the predicted dynamic feature of the management region in the preset future time period.

In some embodiments, the first prediction model may be obtained in a plurality of ways, for example, by training a large number of first training samples with first labels, etc. One set of first training samples includes sample environmental data and a sample dynamic feature for a first time period in history, and the corresponding first labels include a sample dynamic feature for a second time period in history. The first time period in history precedes the second time period in history.

Exemplarily, the government safety monitoring and management platform may obtain historical environmental data and a historical dynamic feature of a historical management region in the first time period in history as the first training sample, and obtain a historical dynamic feature in the second time period in history corresponding to the historical management region as the first label corresponding to the first training sample.

The government safety monitoring and management platform may input the first training samples into an initial first prediction model, obtain outputs of the initial first prediction model; construct a first loss function based on the first labels and the outputs of the initial first prediction model; iteratively update parameters of the initial first prediction model based on the first loss function; until an iteration end condition is met, complete training, and obtain a trained first prediction model. The iteration end condition may include the first loss function converging or a count of iterations reaching a threshold, or the like.

In some embodiments, the second prediction model may be a machine learning model. For example, the second prediction model includes an NN model or other trained machine learning models.

In some embodiments, an input of the second prediction model includes the air data and the environmental data, and an output includes the predicted air data of the management region in the preset future time period.

In some embodiments, the second prediction model may be obtained in a plurality of ways, for example, by training a large number of second training samples with second labels, etc. One set of second training samples includes sample air data and sample environmental data for the first time period in history, and the corresponding second label includes sample air data for the second time period in history.

A process of obtaining the second training samples and the second labels is similar to the process of obtaining the first training samples and the first labels, and a process of training the second prediction model is similar to the process of training the first prediction model, which may be found in the previous related description.

In some embodiments, the input of the first prediction model further includes a surface maintenance plan and transportation planning information of the management region; and the input of the second prediction model further includes a pipeline monitoring parameter of the pipeline monitoring device in the management region.

The surface maintenance plan refers to information related to changes made to a surface in the management region. For example, the surface maintenance plan includes the need to deal with potholes that have appeared as a result of a collapse in a region in the management region, or other situations that require maintenance or repair of the surface.

The transportation planning information refers to information related to control of the road in the management region. For example, the transportation planning information includes information about a road in the management region that needs to be repaired and suspended from use, or other situations that require traffic control.

The pipeline monitoring parameter refers to a type of pipeline information that needs to be obtained through monitoring. In some embodiments, the pipeline monitoring parameter may be determined based on a type of the pipeline monitoring device. For example, when the pipeline monitoring device is a temperature sensor, the pipeline monitoring parameter is temperature, and when the pipeline monitoring device is a humidity sensor, the pipeline monitoring parameter is humidity.

In some embodiments, when the input of the first prediction model also includes the surface maintenance plan and the transportation planning information of the management region, the first training samples further include a sample surface maintenance plan and sample transportation planning information; when the input of the second prediction model also includes the pipeline monitoring parameter of the pipeline monitoring device in the management region, the second training samples further include a sample pipeline monitoring parameter.

In some embodiments of the present disclosure, the input of the first prediction model takes into account some municipal construction information, such as the surface maintenance plan and the transportation planning information, which can take into account the macro changes on the change in pressure on the gas pipeline buried underground; the input of the second prediction model takes into account the pipeline monitoring parameter, which can be relied upon for more data when predicting whether a gas leak will occur in the future, making the final results more accurate.

In some embodiments, the third prediction model may be a machine learning model. For example, the third prediction model includes an NN model or other trained machine learning models.

In some embodiments, an input of the third prediction model includes the ground image information, the predicted dynamic features, and the predicted air data, and an output includes the risk feature of the management region.

In some embodiments, the third prediction model may be obtained by a plurality of ways, for example, by training a large number of third training samples with third labels, etc. One set of third training samples includes sample ground image information, the sample dynamic feature, and the sample air data for the second time period in history, and the corresponding third label includes a sample risk feature for a third time period in history. The second time period in history precedes the third time period in history.

Exemplarily, the government safety monitoring and management platform may obtain historical ground image information, a historical dynamic feature, and historical air data of the historical management region in the second time period in history as the set of third training samples, and determine a historical risk feature of the historical management region in the third time period in history as the corresponding third label.

The government safety monitoring and management platform may count accidents that occurred in the historical management region during the third time period in history, determine a historical accident type according to a type of occurrence of the accidents; take a ratio of a length of time between the occurrence of the accidents and current time and a preset time threshold as a historical risk intensity; and then determine the historical risk feature. The preset time threshold may be expressed in terms of an average time interval of occurrence of the type of accident in the historical data. If there is no accident during the third time period, the third label is marked as 0.

The training process of the third prediction model is similar to that of the first prediction model, which may be found in the previous related description.

In some embodiments of the present disclosure, taking into account the uncertainty of the risk feature itself, the future risk situation can be predicted by the machine learning models, which can be regulated in advance, and can give precautions in advance for the risks that may occur, and reduce the loss.

The gas-related infrastructure refers to various auxiliary devices and structures related to gas transmission, distribution, and utilization. For example, the gas-related infrastructure includes a pressure-regulating device, metering equipment, or the like.

The facility information refers to relevant information characterizing features or attributes of the gas-related infrastructure. For example, the facility information may include, but is not limited to, a type of the gas-related infrastructure, a geographic coordinate of the gas-related infrastructure, or the like.

The risk of facility damage refers to data characterizing the likelihood of damage to the gas-related infrastructure.

In some embodiments, the government safety monitoring and management platform may determine the risk of facility damage in a plurality of ways based on the risk feature and the facility information of the gas-related infrastructure. For example, if the risk type is the active risk, the government safety monitoring and management platform may determine the risk intensity as the risk of facility damage; if the risk type is the passive risk, the government safety monitoring and management platform may determine the risk of facility damage based on correlation between the risk of facility damage and the risk intensity.

Exemplarily, the government safety monitoring and management platform may determine the risk of facility damage based on positive correlation between the risk intensity and the risk of facility damage through a preset formula. The preset formula is shown in formula (4) below:

$$F = a \times R , \qquad ( 4 )$$

wherein, F denotes the risk of facility damage, R denotes the risk intensity, and α denotes a risk factor. α ranges from 0-1, α may be preset by a staff based on experience, or α may be expressed as a ratio of a count of data of the gas-related infrastructure failing in the passive risk to a total count of the passive risk occurrences in the historical data.

In some embodiments, the government safety monitoring and management platform may determine the risk of facility damage based on the risk feature and a facility key value of the gas-related infrastructure.

The facility key value refers to data characterizing degree of criticality of the gas-related infrastructure. The higher the facility key value, the more critical the gas-related infrastructure is. In some embodiments, the facility key value is related to a count of downstream branches and maintenance timeliness of the gas-related infrastructure.

The count of downstream branches refers to a count of pipes that branch off from a current gas-related infrastructure in a direction of a terminal user or other gas pipeline.

The maintenance timeliness refers to data characterizing timeliness of repairs performed on the gas-related infrastructure. The maintenance timeliness is negatively related to an average length of time from fault detection to completion of the maintenance.

In some embodiments, if the risk type is the active risk, the government safety monitoring and management platform may determine the risk intensity as the risk of facility damage; if the risk type is the passive risk, the risk of facility damage is positively related to the facility key value and the risk intensity.

In some embodiments of the present disclosure, when the risk type is the passive risk, it is also necessary to consider the facility key value of the gas-related infrastructure. The more important the facility is, the higher the corresponding risk of facility damage is, to receive greater attention, which ensures that the subsequently identified region to be inspected are more accurate, and any damage can be promptly detected during the inspection of the region to be inspected for subsequent handling.

The preset condition refers to a condition preset and related to determining whether the management region is the region to be inspected. In some embodiments, the preset condition is related to a risk threshold. The preset condition may be that the risk of facility damage in the management region is greater than the risk threshold.

The risk threshold is a preset maximum value for the risk of facility damage.

In some embodiments, the risk threshold is related to gas delivery data of the management region.

The gas delivery data refers to data associated with a gas pipeline in the management region. In some embodiments, the gas delivery data includes a pipeline grade, a terminal user type, or the like.

The pipeline grade is determined based on a count of terminal users connected to the pipeline. The higher the count of the terminal users, the higher the pipeline grade.

The terminal user type refers to a type associated with the user who uses gas, etc. For example, the terminal user type includes a commercial user, a government user, an individual user, or the like.

In some embodiments, the risk threshold is related to the gas delivery data of the management region. For example, the risk threshold is positively related to the pipeline grade. As another example, the risk thresholds corresponding to the commercial user and the government user are higher than the risk threshold for the individual user.

In some embodiments of the present disclosure, the higher the pipeline grade, the more critical the pipeline, and the stricter the risk control required. Furthermore, considering the terminal user type, stricter risk control is necessary for the commercial user and the government user, which has a broader impact, compared to the individual user. Strict risk control facilitates timely responses to pipeline changes, thereby reducing potential losses.

In some embodiments, the government safety monitoring and management platform may compare the risk of facility damage with the risk threshold, and if the risk of facility damage is greater than the risk threshold, then determine that the preset condition is satisfied, and identify the management region as the region to be inspected.

In some embodiments of the present disclosure, by determining the dynamic feature and the risk feature of the management region, the accuracy of determining the risk of facility damage can be improved, and the region to be inspected can be determined, which is conducive to the scheduling of the staff to carry out repairs for the region at risk. Conducting inspections specifically for risks caused by facility failures can reduce resource wastage on investigating issues unrelated to facility malfunctions.

FIG. 4 is an exemplary flowchart illustrating a process for determining an inspection parameter according to some embodiments of the present disclosure.

In some embodiments, in response to determining that a management region is identified as a region to be inspected, determining an inspection parameter of the region to be inspected includes: obtaining a surface maintenance plan, transportation planning information, management resource data of the region to be inspected, and historical maintenance data of a gas pipeline in the region to be inspected from the government safety monitoring and management platform, determining an inspection priority of the region to be inspected based on the surface maintenance plan and the transportation planning information, and determining the inspection parameter based on the inspection priority, the management resource data, and the historical maintenance data.

In some embodiments, a process 400 includes the following operations, as shown in FIG. 4. The process 400 may be performed by the government safety monitoring and management platform.

In 410, the surface maintenance plan, the transportation planning information, the management resource data of the region to be inspected, and the historical maintenance data of the gas pipeline in the region to be inspected may be obtained from the government safety monitoring and management platform.

The management resource data refers to data related to resource features in the region to be inspected. For example, the management resource data may include a count of maintenance personnel, a count of spare resources, or the like. The count of spare resources includes a count of spare facilities that are gas-related infrastructures.

In some embodiments, the government safety monitoring and management platform may obtain the surface maintenance plan, the transportation planning information, and the management resource data of the region to be inspected in real time over a network and store the surface maintenance plan, the transportation planning information, and the management resource data of the region to be inspected in the government safety monitoring and management platform for use as needed.

The historical maintenance data refers to data related to maintenance of the gas pipeline in the region to be inspected at historical times. For example, the historical maintenance data may include time when the maintenance is performed and a type of accident for which the maintenance is performed.

The accident type refers to a type of failure that occurred in the gas pipeline. For example, the accident type includes gas pipeline rupture, valve damage, or the like.

In some embodiments, after a gas pipeline breaks down, maintenance data generated by the maintenance is uploaded to the government safety monitoring and management platform for storage, thereby ensuring that the maintenance data may be accessed from the government safety monitoring and management platform when needed.

In 420, the inspection priority of the region to be inspected may be determined based on the surface maintenance plan and the transportation planning information.

More details regarding the surface maintenance plan and the transportation planning information may be found in the corresponding description of FIG. 3.

The inspection priority refers to a hierarchical criterion used to guide an order of processing and resource allocation for inspections of a plurality of regions to be inspected. The inspection priority is related to the importance of the region to be inspected, and the more important the region to be inspected, the higher the inspection priority.

In some embodiments, the government safety monitoring and management platform may determine the inspection priority of the region to be inspected in a plurality of ways based on the surface maintenance plan and the transportation planning information. For example, the government safety monitoring and management platform may determine whether the region to be inspected is in the surface maintenance plan and the transportation planning information, and if both are present, the inspection priority is the highest; if only in the surface maintenance plan, the inspection priority is the second; if only in the transportation planning information, the inspection priority is the third; if neither is present, the inspection priority is the lowest.

In some embodiments, the inspection priority is further related to a facility key value of a gas-related infrastructure in the region to be inspected. More details regarding the gas-related infrastructure and the facility key value may be found in the corresponding description of FIG. 3.

In some embodiments, the inspection priority is positively related to the facility key value of the gas-related infrastructure in the region to be inspected.

In some embodiments of the present disclosure, when setting the inspection priority, the importance of the gas-related infrastructure is taken into account, which allows for the prioritization of the regions with more critical pipelines, ensuring that resources are allocated effectively.

In 430, the inspection parameter may be determined based on the inspection priority, the management resource data, and the historical maintenance data.

In some embodiments, the government safety monitoring and management platform may determine the inspection parameter based on the inspection priority, the management resource data, and the historical maintenance data.

For example, for a region to be inspected with a higher inspection priority, if there are fewer management resources, the inspection parameter includes using an unmanned inspection device to conduct inspection; if there are more management resources, the inspection parameter includes dispatching an inspector to conduct inspection; for a region to be inspected with a lower inspection priority, if there are fewer management resources, the inspection parameter includes using the unmanned inspection device to conduct inspection; if there are more management resources, the inspection parameter includes using a pipeline monitoring device to conduct inspection.

In some embodiments, the government safety monitoring and management platform may determine an accident probability through a probability prediction model based on a candidate inspection parameter, the inspection priority, the management resource data, and the historical maintenance data; and determine the inspection parameter based on the accident probability.

The candidate inspection parameter refers to a parameter that is used as an alternative inspection parameter.

In some embodiments, the government safety monitoring and management platform may obtain the candidate inspection parameter based on historical inspection parameters. For example, the government safety monitoring and management platform may count a count of times of each historical inspection parameter occurring in the historical data, and take a preset count of historical inspection parameters with the highest count of times as the candidate inspection parameters. The value of the preset count is determined based on actual needs.

The accident probability refers to a probability of an accident occurring in the region to be inspected.

The probability prediction model refers to a model used to determine the accident probability. In some embodiments, the probability prediction model is a machine learning model. For example, the probability prediction model includes an NN model or other trained machine learning models.

In some embodiments, an input of the probability prediction model includes the candidate inspection parameter of the region to be inspected, the inspection priority, the management resource data, the historical maintenance data, and an output includes the accident probability.

In some embodiments, the probability prediction model may be obtained by training an initial probability prediction model based on a large number of fourth training samples with fourth labels. One set of fourth training samples includes a sample inspection parameter, a sample inspection priority of a sample region to be inspected, sample management resource data, and sample maintenance data for a gas pipeline in the sample region to be inspected, and the corresponding fourth label includes a sample accident probability corresponding to the sample region to be inspected.

Exemplarily, the government safety monitoring and management platform may obtain the historical inspection parameters in the historical data, a historical inspection priority of a historical region to be inspected, historical management resource data, and historical maintenance data of a gas pipeline in the historical region to be inspected as the fourth training sample, and take a subsequent actual accident probability as the fourth label corresponding to the fourth training sample.

The subsequent actual accident probability refers to a probability of occurrence of an accident during execution time of the historical inspection parameter. The execution time refers to time required to complete the inspection using the inspection parameter. In some embodiments, the government safety monitoring and management platform may count a frequency of subsequent actual accidents within the execution time of the historical inspection parameter in the historical data, determine a ratio of the frequency to the execution time, perform normalization processing on the ratio, and determine the result as the subsequent actual accident probability. The normalization processing refers to a process of converting the ratio of the frequency to the execution time to a value between 0 and 1.

A training process of the probability prediction model is similar to that of a first prediction model, which may be found in the corresponding description of the previous section.

In some embodiments, the government safety monitoring and management platform may split a sample data set according to a preset ratio to obtain a training set, a validation set, and a test set; and train the initial probability prediction model based on the training set, the validation set, and the test set to obtain the probability prediction model.

The preset ratio refers to a predefined ratio of the training set, the validation set, and the test set. For example, the preset ratio may be a ratio of 8:1:1 of a count of samples included in the training set, the validation set, and the test set.

In some embodiments, the preset ratio may be set by default by the government safety monitoring and management platform or preset based on a priori experience.

In some embodiments, the government safety monitoring and management platform may split the sample data set based on the preset ratio to obtain the training set, the validation set, and the test set.

Ways of splitting include sampling statistics. The sampling statistics include, but are not limited to, random sampling, stratified sampling, or the like. In some embodiments, the gas company management platform may also split the sample data set in other ways.

The training set refers to a dataset used to adjust learning parameters of the model during model training. The learning parameters include parameters such as weights, biases, or the like. The validation set refers to a dataset used to tune model hyperparameters during model training. The hyperparameters include a count of network layers, a count of network nodes, a count of iterations, and a learning rate. The test set refers to a dataset used to evaluate performance of the final model.

The training set, the validation set, and the test set obtained by splitting have no data crossover, i.e., there is no duplicate data between any two of the training set, the validation set, and the test set.

In some embodiments, the government safety monitoring and management platform may train the initial probability prediction model based on the training set, the validation set, and the test set to obtain the probability prediction model.

The training process includes a plurality of stages of training. One stage of training includes: inputting the training set into the initial probability prediction model, constructing a loss function based on the fourth label and an output of the initial probability prediction model, updating parameters of the initial probability prediction model; in the foregoing training process, validating a trained initial probability prediction model through the validation set based on a preset validation frequency, adjusting an initial learning rate or the learning rate of the initial probability prediction model during the training process after the round of training based on the validation results; when a preset condition is triggered, testing the already obtained probability prediction model through the test set to assess performance of the already obtained probability prediction model. The plurality of stages of training are performed and the probability prediction model with the best performance is used as the trained probability prediction model.

Tuning the learning rate may be performed using a plurality of strategies, for example, one or more of manners such as a learning rate decay strategy, a learning rate warm-up, a cyclic learning rate, and the use of an adaptive learning rate tuning algorithm.

The preset condition may include one or more of a count of iterations reaching a threshold, the loss function converging, and the value of the loss function being less than a preset threshold.

The above training process of the model using the training set, the validation set, and the test set is provided merely as an example, and other processes known to those of skill in the art may be used in training the model based on the training set, the validation set, and the test set.

In some embodiments, the sample data set may be randomly divided into a plurality of sets of sample data, a set of sample data may be divided into the training set, the validation set, and the test set based on the preset ratio as described before, and the government safety monitoring and management platform may conduct the training process for the initial probability prediction model based on the plurality of sets of divided sample data.

In some embodiments, the learning rate corresponding to the set of sample data is related to a count of sample maintenance data in the set of sample data, and the larger the count of the sample maintenance data, the larger the learning rate corresponding to the set of sample data. The large number of the sample maintenance data refers to a high count of maintenance records within the set of sample data.

In some embodiments of the present disclosure, training based on the training set, the validation set, and the test set can obtain a more suitable probability prediction model, which is conducive to enhancing the robustness of the probability prediction model and prevents overfitting. The greater the amount of historical maintenance data, the higher the uncertainty of pipeline accidents in the region to be inspected, and the more critical the region becomes. By increasing the learning rate of the sample data corresponding to the region to be inspected, the accuracy and efficiency of the probability prediction model can be improved.

In some embodiments, the input of the probability prediction model further includes a pipeline monitoring parameter of the pipeline monitoring device in the region to be inspected.

More details regarding the pipeline monitoring parameter may be found in the corresponding description of FIG. 3.

When the input of the probability prediction model also includes the pipeline monitoring parameter, the sample data set also includes a sample pipeline monitoring parameter.

In some embodiments of the present disclosure, the input of the probability prediction model also considers the pipeline monitoring parameter. The essence of the approach lies in considering the specific conditions of the pipeline, ensuring it aligns with the actual state of the pipeline. By accounting for the wear and tear caused by internal gases on the pipeline, the determined accident probability becomes more comprehensive and accurate.

In some embodiments of the present disclosure, by evaluating the accident probability of the region to be inspected, the inspection parameter suitable for the region to be inspected can be screened from the perspective of accident prevention, thereby reducing the accident probability.

In some embodiments of the present disclosure, the importance of the region to be inspected is assessed based on the surface maintenance plan and the transportation planning information, and the inspection priority is obtained, which can ensure the accuracy of the inspection priority; at the same time, the inspection priority is conducive to resource allocation and finding a more suitable inspection program for the region to be inspected.

The basic concepts have been described above, and it is apparent to a person skilled in the art that the above detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe the exemplary embodiments of the present disclosure. Such as “an embodiment”, “one embodiment”, and/or “some embodiment” means a feature, structure, or feature associated with at least one embodiment of the present disclosure. Accordingly, it should be emphasized and noted that “one embodiment” or “an embodiment” or “an alternative embodiment” in different places in the present disclosure do not necessarily refer to the same embodiment. In addition, certain features, structures, or features in one or more embodiments of the present disclosure may be suitably combined.

Additionally, unless expressly stated in the claims, the order of the processing elements and sequences, the use of numerical letters, or the use of other names as described in the present disclosure are not intended to qualify the order of the processes and methods of the present disclosure. While some embodiments of the invention that are currently considered useful are discussed in the foregoing disclosure by way of various examples, it is to be understood that such details serve only illustrative purposes and that additional claims are not limited to the disclosed embodiments!, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes combine a variety of features into a single embodiment, accompanying drawings, or the description thereof. However, this method of disclosure does not imply that the objects of the present disclosure require more features than those mentioned in the claims. Rather, claimed subject matter may lie in less than all features of a single foregoing disclosed embodiment.

Finally, it should be understood that the embodiments described in the present disclosure are used only to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A system for smart gas unmanned inspection based on an Internet of Things (IoT), comprising a government safety monitoring and management platform, a government safety monitoring sensor network platform, a government safety monitoring object platform, a gas company sensor network platform, and a gas inspection object platform; wherein
the gas inspection object platform includes an unmanned inspection device; and the government safety monitoring object platform includes a gas company management platform;
the government safety monitoring and management platform is configured to:
obtain, through the government safety monitoring sensor network platform, region data of a management region from the gas company management platform in the government safety monitoring object platform, the region data including at least one of ground image information, macroscopic image information, air data, and environmental data; wherein the gas company management platform obtains the region data from the gas inspection object platform through the gas company sensor network platform;
determine whether to identify the management region as a region to be inspected based on the region data and traffic data of the management region;
in response to determining that the management region is identified as the region to be inspected, determine an inspection parameter of the region to be inspected; and
send the inspection parameter to the government safety monitoring object platform to control at least one of the pipeline monitoring device, the inspector, and the unmanned inspection device to complete an inspection of the region to be inspected.

2. The system according to claim 1, wherein the government safety monitoring and management platform is further configured to:
determine a dynamic feature of the management region based on the macroscopic image information and the traffic data;
determine a risk feature of a gas pipeline in the management region based on the ground image information, the environmental data, the air data, and the dynamic feature;
determine a risk of facility damage based on the risk feature and facility information of a gas-related infrastructure; and
in response to determining that the risk of facility damage satisfies a preset condition, identify the management region as the region to be inspected, the preset condition being related to a risk threshold.

3. The system according to claim 2, wherein the government safety monitoring and management platform is further configured to:
determine the dynamic feature based on the macroscopic image information, the traffic data, and noise information and vibration information in the management region.

4. The system according to claim 2, wherein the government safety monitoring and management platform is further configured to:
determine the risk of facility damage based on the risk feature and a facility key value of the gas-related infrastructure, the facility key value being related to a count of downstream branches and maintenance timeliness of the gas-related infrastructure.

5. The system according to claim 2, wherein the government safety monitoring and management platform is further configured to:
determine a predicted dynamic feature of the management region in a preset future time period through a first prediction model, based on the environmental data and the dynamic feature;
determine predicted air data of the management region in the preset future time period through a second prediction model, based on the air data and the environmental data; and
determine the risk feature of the management region through a third prediction model based on the ground image information, the predicted dynamic feature of the management region, and the predicted air data of the management region;
wherein the first prediction model, the second prediction model, and the third prediction model are machine learning models.

6. The system according to claim 1, wherein the government safety monitoring and management platform is further configured to:
obtain a surface maintenance plan, transportation planning information, management resource data of the region to be inspected, and historical maintenance data of a gas pipeline in the region to be inspected from the government safety monitoring and management platform;
determine an inspection priority of the region to be inspected based on the surface maintenance plan and the transportation planning information; and
determine the inspection parameter based on the inspection priority, the management resource data, and the historical maintenance data.

7. The system according to claim 6, wherein the government safety monitoring and management platform is further configured to:
determine an accident probability through a probability prediction model based on a candidate inspection parameter, the inspection priority, the management resource data, and the historical maintenance data, the probability prediction model being a machine learning model; and
determine the inspection parameter based on the accident probability.

8. A method for smart gas unmanned inspection based on an Internet of Things (IoT), wherein the method is executed by a government safety monitoring and management platform of a system for smart gas unmanned inspection based on the IoT, and the method comprises:
obtaining, through a government safety monitoring sensor network platform, region data of a management region from a gas company management platform in a government safety monitoring object platform, the region data including at least one of ground image information, macroscopic image information, air data, and environmental data; wherein the gas company management platform obtains the region data from a gas inspection object platform through a gas company sensor network platform;
determining whether to identify the management region as a region to be inspected based on the region data and traffic data of the management region;
in response to determining that the management region is identified as the region to be inspected, determining an inspection parameter of the region to be inspected; the inspection parameter being related to at least one of a pipeline monitoring device, an inspector, and an unmanned inspection device; and
sending the inspection parameter to the government safety monitoring object platform to control at least one of the pipeline monitoring device, the inspector, and the unmanned inspection device to complete an inspection of the region to be inspected.

9. The method according to claim 8, wherein the determining whether to identify the management region as a region to be inspected based on the region data and traffic data of the management region includes:
determining a dynamic feature of the management region based on the macroscopic image information and the traffic data;
determining a risk feature of a gas pipeline in the management region based on the ground image information, the environmental data, the air data, and the dynamic feature;
determining a risk of facility damage based on the risk feature and facility information of a gas-related infrastructure; and
in response to determining that the risk of facility damage satisfies a preset condition, identifying the management region as the region to be inspected, the preset condition being related to a risk threshold.

10. The method according to claim 9, further comprising:
determining the dynamic feature based on the macroscopic image information, the traffic data, and noise information and vibration information in the management region.

11. The method according to claim 9, wherein the risk threshold is related to gas delivery data of the management region.

12. The method according to claim 9, wherein the determining a risk of facility damage based on the risk feature and facility information of a gas-related infrastructure, includes:
determining the risk of facility damage based on the risk feature and a facility key value of the gas-related infrastructure, the facility key value being related to a count of downstream branches and maintenance timeliness of the gas-related infrastructure.

13. The method according to claim 9, wherein the determining a risk feature of a gas pipeline in the management region based on the ground image information, the environmental data, the air data, and the dynamic feature, includes:
determining a predicted dynamic feature of the management region in a preset future time period through a first prediction model, based on the environmental data and the dynamic feature;
determining predicted air data of the management region in the preset future time period through a second prediction model, based on the air data and the environmental data; and
determining the risk feature of the management region through a third prediction model based on the ground image information, the predicted dynamic feature of the management region, and the predicted air data of the management region;
wherein the first prediction model, the second prediction model, and the third prediction model are machine learning models.

14. The method according to claim 13, wherein an input of the first prediction model further includes a surface maintenance plan and transportation planning information of the management region; and an input of the second prediction model further includes a pipeline monitoring parameter of the pipeline monitoring device in the management region.

15. The method according to claim 8, wherein the in response to determining that the management region is identified as the region to be inspected, determining an inspection parameter of the region to be inspected includes:
obtaining a surface maintenance plan, transportation planning information, management resource data of the region to be inspected, and historical maintenance data of a gas pipeline in the region to be inspected from the government safety monitoring and management platform;
determining an inspection priority of the region to be inspected based on the surface maintenance plan and the transportation planning information; and
determining the inspection parameter based on the inspection priority, the management resource data, and the historical maintenance data.

16. The method according to claim 15, wherein the inspection priority is further related to a facility key value of a gas-related infrastructure in the region to be inspected.

17. The method according to claim 15, wherein the determining the inspection parameter based on the inspection priority, the management resource data, and the historical maintenance data, includes:
determining an accident probability through a probability prediction model based on a candidate inspection parameter, the inspection priority, the management resource data, and the historical maintenance data, the probability prediction model being a machine learning model; and
determining the inspection parameter based on the accident probability.

18. The method according to claim 17, wherein an input of the probability prediction model further includes a pipeline monitoring parameter of the pipeline monitoring device in the region to be inspected.

19. The method according to claim 17, further comprising:
splitting a sample data set according to a preset ratio to obtain a training set, a validation set, and a test set; the training set, the validation set, and the test set having no data crossover, and the sample data set including a sample inspection parameter, a sample inspection priority of a sample region to be inspected, sample resource data, and sample maintenance data of a sample gas pipeline in the sample region to be inspected; and
training an initial probability prediction model based on the training set, the validation set, and the test set to obtain the probability prediction model; wherein
the sample data set includes a plurality of sets of sample data, and a learning rate corresponding to a set of sample data is related to a count of sample maintenance data in the set of sample data.

20. A non-transitory computer-readable storage medium storing computer instructions, wherein when a computer reads the computer instructions in the storage medium, the computer implements the method for smart gas unmanned inspection based on the IoT of claim 1.
